(19) United States
(12) Patent Application Publication
(10) Pub. No.: US 2015/0363134 A1
(43) Pub. Date: Dec. 17, 2015

(54) STORAGE APPARATUS AND DATA MANAGEMENT

(71) Applicant: Hitachi, Ltd., Tokyo (JP)

(72) Inventors: Kazuei HIRONAKA, Tokyo (JP); Sadahiro SUGIMOTO, Tokyo (JP); Shigeo HOMMA, Tokyo (JP)

(21) Appl. No.: 14/124,127

(22) PCT Filed: Mar. 4, 2013
(86) PCT No.: PCT/JP2013/055848

§ 371 Date: Dec. 5, 2013

(51) Int. Cl. G06F 3/06

(52) U.S. Cl. CPC G06F 3/0641; G06F 3/0626; G06F 3/0683

(57) ABSTRACT

Access performance of a storage apparatus to which a deduplication technique is applied is enhanced.

A storage apparatus includes: a plurality of storage media; a cache memory; a control unit for controlling inputting of data to, and outputting of data from, the storage media, wherein the control unit: provides a host system with a first storage area composed of storage areas of the plurality of storage media and a second storage area having the same performance characteristic as that of the storage media which provide the first storage area; and stores a first data row, which is deduplicated, in the first storage area and a second data row, which is created based on a data row that is the first data row before being deduplicated, in consecutive areas of physical areas composed of the second storage area.

### TECHNICAL FIELD

The present invention relates to a storage apparatus and a data management method and is suited for use in a storage apparatus having a deduplication function and a data management method.

### BACKGROUND ART

Recently, there has been a tendency for a data amount in a company to increase explosively and it is necessary to accumulate a large amount of data at low cost. So, there is an increasing need for data amount reduction techniques to reduce the data amount to be stored in storage apparatuses and reduce a capacity unit price of the apparatuses. Particularly, data mining for acquiring new information by means of data analysis has been being performed in recent years in order to acquire somewhat meaningful information from a large amount of accumulated data. It can be predicted that data accumulated in a storage apparatus will be accessed for some kind of analysis by a large number of computers connected to the storage apparatus.

So, attention has been focused on data deduplication processing for detecting and eliminating duplicate data in order to inhibit increase of the amount of data stored in storage areas and enhance data capacity efficiency. For example, regarding a data row which is to be stored in a storage apparatus, Patent Literature 1 distinguishes part of the data row which duplicates another data row (duplicate part), from part of the data row which does not include any duplicate data (non-duplicate part), and manages them as chunks. Then, when storing data in a drive, Patent Literature 1 stores only data of non-duplicate part chunks in the drive and manage them, while it manages duplicate part chunks as pointers indicating chunks which duplicate the data already stored in the drive. Accordingly, Patent Literature 1 discloses the deduplication technique to reduce the data amount to be actually stored in the drive by not recording data of such duplicate chunks in the drive as described above.

### CITATION LIST

### Patent Literature

[Patent Literature 1] Japanese Patent Application Laid-Open (Kokai) Publication No. 2009-181148

### SUMMARY OF INVENTION

### Problems to be Solved by the Invention

However, Patent Literature 1 requires the operation to collect divided chunks from discontinuous addresses in the drive and restore them to their original data row in order to restore the original data row from the data row which has been deduplicated once. Therefore, when this drive is a storage medium such as a HDD (Hard Disk Drive) whose access performance varies greatly between a case of random data access and a case of sequential data access, there is a problem of extreme performance degradation if deduplication is performed.

The present invention was devised in consideration of the above-described circumstance and is intended to propose enhancement of access performance of a storage apparatus to which the deduplication technique is applied. The invention also proposes a storage apparatus and data management method capable of efficiently restoring deduplicated data.

### Means for Solving the Problems

In order to solve the above-described problems, provided according to the present invention is a storage apparatus including: a plurality of storage media; a cache memory; and a control unit for controlling inputting of data to, and outputting of data from, the storage media, wherein the control unit: provides a host system with a first storage area composed of storage areas of the plurality of storage media and a second storage area having the same performance characteristic as that of the storage media which provide the first storage area; and stores a first data row, which is deduplicated, in the first storage area and a second data row, which is created based on a data row that is the first data row before being deduplicated, in consecutive areas of physical areas composed of the second storage area.

According to such a configuration, the first data row which is deduplicated is stored in the first storage area and the second data row is stored in the consecutive areas of the physical areas constituting the second storage area. As a result, data stored in the consecutive areas, but not deduplicated and fragmented data, can be staged and it is thereby possible to enhance access performance.

### Advantageous Effects of Invention

The performance of the storage apparatus which stores deduplicated data can be enhanced according to the present invention.

### BRIEF DESCRIPTION OF DRAWINGS

FIG. 1 is a conceptual diagram for explaining the problems to be solved by the present invention.

FIG. 2 is a block diagram illustrating a hardware configuration according to the embodiment.

FIG. 3 is a block diagram illustrating an internal configuration of a storage apparatus according to the embodiment.

FIG. 4 is a conceptual diagram for explaining logical volumes according to the embodiment.

FIG. 5 is a conceptual diagram for explaining a data management unit according to the embodiment.

FIG. 6 is a chart illustrating a deduplication address conversion table according to the embodiment.

FIG. 7 is a chart illustrating a chunk management table according to the embodiment.

FIG. 8 is a chart illustrating a cache volume management table according to the embodiment.

FIG. 9 is a chart illustrating a cache memory management table according to the embodiment.

FIG. 10 is a flowchart illustrating destaging processing according to the embodiment.

FIG. 11 is a flowchart illustrating deduplication processing according to the embodiment.

FIG. 12 is a flowchart illustrating destaging processing on a deduplicated volume according to the embodiment.

FIG. 13 is a flowchart illustrating caching processing on a cache volume according to the embodiment.

FIG. 14 is a flowchart illustrating read processing according to the embodiment.

FIG. 15 is a block diagram illustrating an internal configuration of a storage apparatus according to a second embodiment of the present invention.

FIG. 16 is a block diagram illustrating an internal configuration of a storage apparatus according to a third embodiment of the present invention.

FIG. 17 is a block diagram illustrating an internal configuration of a storage apparatus according to a fourth embodiment of the present invention.

### DESCRIPTION OF EMBODIMENTS

An embodiment of the present invention will be explained below in detail with reference to the relevant drawings.

Incidentally, embodiments described below not intended to limit the invention according to the scope of claims and all combinations of elements explained in the embodiments are not necessarily requisite to the means for solving the problems according to the invention.

Moreover, various kinds of information may sometimes be explained by using the expression “xxx table”; however, various kinds of information may be expressed with a data structure other than a table and the expression “xxx information” can be also used instead of “xxx table” in order to indicate that various kinds of information do not depend on the data structure. Moreover, a “program” may be used as a subject in the following explanation in order to describe processing. As a program is executed by a processor (for example, CPU [Central Processing Unit]) to perform defined processing by using memory resources (for example, a memory) and/or communications I/Fs (for example, communication ports), the subject of the processing may be the program.

Processing described by using a program as a subject may be processing executed by a processor or a computer having the processor, such as a host computer or a storage apparatus. Moreover, the expression “controller” may indicate a processor or a hardware circuit for executing any part of or the whole of the processing executed by the processor. A program may be installed from a program source to each computer and a program source may be, for example, a nonvolatile memory or a storage medium.

### (1) First Embodiment

### (1-1) Outline of this Embodiment

Firstly, the outline of this embodiment will be explained. There is the above-described problem of extreme performance degradation when if deduplication is performed using a storage medium such as an HDD when restoring a data row, which has been deduplicated once, to its original data row during deduplication processing. So, attempts have been made to mount a cache memory in a storage apparatus or use storage media such as SSDs (Solid State Drives) whose performance will not change extremely, unlike HDDs, depending on access characteristics. However, in a case of a storage apparatus intended to accumulate a large amount of data at low cost, it is required to mainly mount storage media of a relatively low capacity unit price such as HDDs as drives to be mounted, thereby reducing the capacity unit price of the storage apparatus and storing large-scale data sets to be used for, for example, data mining at lower cost. Moreover, since the total capacity of the drives mounted in the storage apparatus increases, it can be predicted that a cache memory amount to be mounted will become significantly smaller than the total drive capacity.

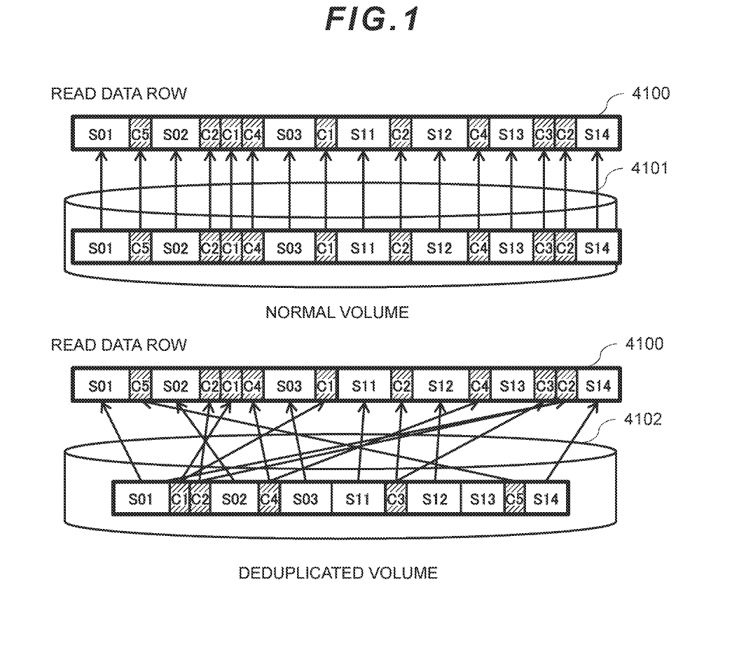

Specifically speaking, the problem caused when restoring a deduplicated data row during deduplication processing will be explained with reference to FIG. 1. FIG. 1 illustrates a case where data which has not been deduplicated or deduplicated data are read respectively. The upper part of FIG. 1 illustrates a case where a read data row 4100 is read from a normal volume 4101 in which data is stored without being deduplicated. Moreover, the lower part of FIG. 1 illustrates a case where the read data row 4100 is read from a deduplicated volume 4102 storing data obtained by removing duplicate parts from the data row on which the deduplication processing has been executed. Referring to FIG. 1, reference signs such as S01, S02, S03 and so on represent data of the read data row 4100 which do not duplicate another data row (shaded parts); and reference signs such as C1, C2, C3 and so on represent data which duplicate another data row (nonshaded parts).

Since the deduplication processing is not executed on data in the normal volume 4101 in the upper part of FIG. 1, the normal volume stores all pieces of data including data which do not duplicate another data row (S01, S02, S03 and so on) and data which duplicate another data row (C1, C2, C3 and so on). Accordingly, when reading data from the normal volume 4101 which has not been deduplicated, the data can be restored by reading the read data row 4100 as it is.

Moreover, since the deduplication processing has been executed on data in the deduplicated volume 4102 in the lower part of FIG. 1, the deduplicated volume stores data, which do not duplicate another data row (S01, S02, S03 and so on), and each one piece of duplicate data which duplicate another data row (C1, C2, C3 and so on). Therefore, the deduplicated volume 4102 stores non-duplicate data which do not duplicate other data.

Then, when reading the data from the deduplicated volume 4102 which has been deduplicated, it is necessary to read the data from the non-duplicate data to form the read data row 4100 in accordance with a management table to manage the deduplicated volume 4102. For example, since the deduplicated data C1 appears in the fifth and eighth positions of the read data row, the duplicate data C1 which is stored in the second position of the non-duplicate data in the deduplicated volume 4102 is read twice to restore data. Therefore, with the deduplicated volume 4102 storing the data on which the deduplication processing was executed, the duplicate part data and the non-duplicate part data are stored at discontinuous positions in the drive with respect to the read data row.

So, sequential reading is performed on the volume to read data sequentially, while random reading may sometimes be performed on the drive to read data randomly. As a result, if the deduplication processing is executed on the volume composed of an HDD, a problem of extreme degradation occurs in sequential reading performance of the deduplicated volume as compared to the volume which has the same configuration, but has not been deduplicated.

Therefore, according to this embodiment, a data row which should be stored in a deduplicated volume is divided by the deduplication processing into data which duplicates another data row (duplicate part data) and data which does not include the duplicate data (non-duplicate part data); the non-duplicate part data are stored in the deduplicated volume; and the duplicate part data are collectively stored in an unused area with consecutive addresses. Then, when reading data from a certain range of the deduplicated volume, the non-duplicate part data included in that range is read from the deduplicated volume; and regarding the duplicate part data, the duplicate part data recorded in the unused areas of the drive are collectively read and staged to the cache memory. As a result, the data can be read from the relatively consecutive addresses in the drive constituting the deduplicated volume, so that the speed of sequential reading performance from the deduplicated volume can be increased.

### (1-2) Hardware Configuration of Computer System

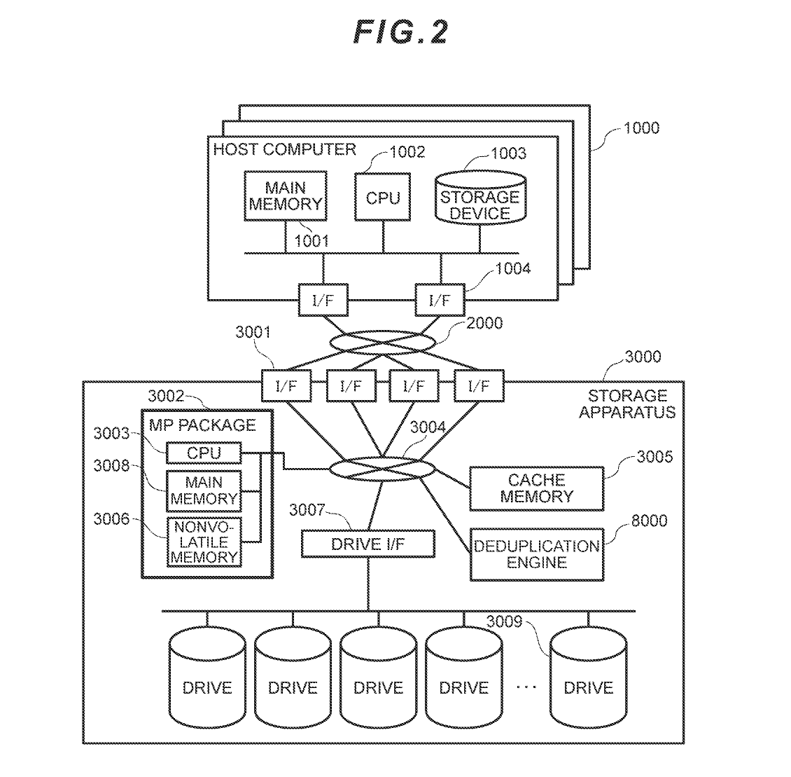

Hardware configuration of a computer system according to this embodiment will be explained. The computer system is configured as illustrated in FIG. 2 host computer 1000 and a storage apparatus 3000 are connected via a network 2000.

The host computer 1000 is composed of, for example, a general server system and includes a main memory 1001, a CPU 1002, a storage device 1003, and a network interface (which is indicated as I/F in the drawing) 1004.

The CPU 1002 functions as an arithmetic processing unit and controls the operation of the entire host computer 1000 in accordance with, for example, various programs and operation parameters stored in the storage device 1003. The CPU 1003 executes, for example, control programs by loading them from the storage device 1003 onto the main memory 1001. The storage device 1003 is composed of, for example, HDDs (Hard Disk Drives), and stores programs executed by the CPU 1002 and various data. The network interface 1004 is a communications interface composed of, for example, communication devices for connecting to, for example, the network 2000. The host computer 1000 is connected to the network 2000 via the network interface 1004.

The network 2000 is composed of, for example, a SAN (Storage Area Network) or Ethernet (registered trademark).

The storage apparatus 3000 interprets commands sent from the host computer 1000 and executes reading/writing data from/to storage areas in a drive 3009. The storage apparatus 3000 includes a network interface (which is indicated as I/F in the drawing) 3001, a microprocessor package (which is indicated as MP package in the drawing) 3002, an internal network 3004, a cache memory 3005, a drive interface (which is indicated as Drive I/F in the drawing) 3007, a drive 3009, and a deduplication engine 8000. Regarding the inside of the storage apparatus 3000, the network interface 3001, the microprocessor package 3002, the cache memory 3005, the drive interface 3007, and the deduplication engine 8000 are connected via the internal network 3004.

The microprocessor package 3002 is composed of a CPU 3003, a main memory 3008, and a nonvolatile memory 3006.

The CPU 3003 functions as an arithmetic processing unit and controls the operation of the entire host computer 1000 in accordance with, for example, various programs and operation parameters stored in the main memory 1001. Specifically speaking, the CPU 3003 executes processing of read or write commands from the host computer 1000 and executes data transfer between the drive 3009 and the cache memory 3005 via drive interface 3007.

The nonvolatile memory 3006 is a memory storing, for example, control programs for the storage apparatus to be executed by the CPU 3003. The CPU 3003 loads, for example, the control programs from the nonvolatile memory 3006 to the main memory 3008 and executes them.

The cache memory 3005 is a memory composed of a DRAM (Dynamic Random Access Memory) or an SRAM (Static Random Access Memory) capable of high-speed access in order to enhance I/O processing throughput and responses of the storage apparatus 3000 and stores, for example, a data area for temporarily caching data and management data for the storage apparatus 3000.

The drive 3009 is a data recording device connected to the storage apparatus 3000 and is composed of, for example, HDDs or SSDs.

The deduplication engine 8000 is a device for executing the deduplication processing according to this embodiment. The details of the deduplication processing by the deduplication engine 8000 will be explained later.

### (1-3) Internal Configuration of Storage Apparatus

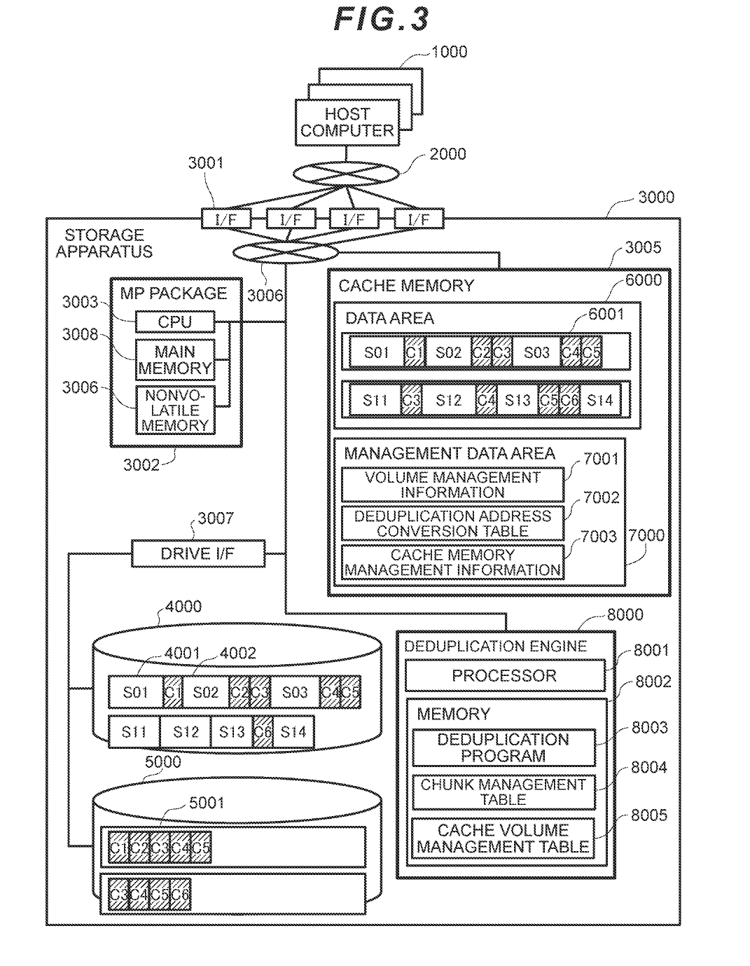

Next, the internal configuration of the storage apparatus 3000 according to this embodiment will be explained. FIG. 3 illustrates the internal configuration of the storage apparatus 3000 shown in FIG. 2. The configuration related to the deduplication processing will be explained below particularly in detail.

The cache memory 3005 is managed by being logically divided into a data area 6000 and a management data area 7000 as illustrated in FIG. 3.

The management data area 7000 is an area for storing control information required to execute functions of the storage apparatus 3000 and stores, for example, volume management information 7001, a deduplication address conversion table 7002, and cache memory management information 7003.

The volume management information 7001 stores information for managing association between logical volumes provided to the host computer 1000 and physical drives corresponding to the logical volumes. The logical volumes are configured by means of Thin Provisioning. The details of thin provisioning will be explained later.

The deduplication address conversion table 7002 is a table for managing information to convert a logical address of a deduplicated volume into its corresponding physical address. The cache memory management table 7003 is management information about the data area 6000. The data area 6000 is an area where data is cached when data sent from the host computer 1000 is received by the storage apparatus 3000 or data read from a volume of the storage apparatus 3000 is sent to the host.

The deduplication engine 8000 is composed of, for example, a processor 8001 and a memory 8002 and is a processing unit for executing the deduplication processing at timing when data stored in the data area 6000 of the cache memory 3005 is removed on a slot 6001 basis from the cache memory 3005.

The processor 8001 loads a deduplication program 8003 from the memory 8002 and executes the deduplication processing on the data of the slot 6001 removed from the cache memory 6000. The chunk management table 8004 is a table for managing chunks stored in a deduplicated volume 4000. The cache volume management table 8005 is a table for managing duplicate part chunks 5001 of a cache volume 5000.

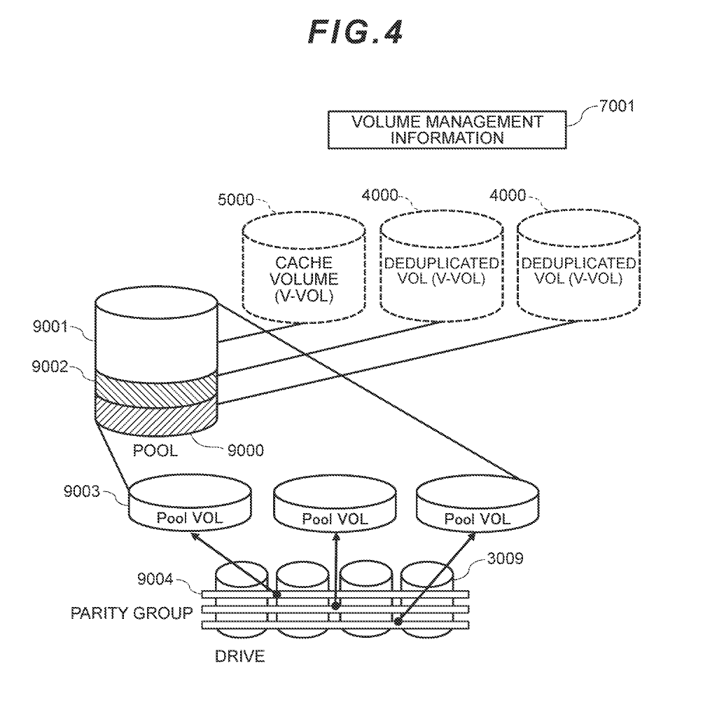

Now, the deduplicated volume 4000 and the cache volume 5000 will be explained with reference to FIG. 4. The deduplicated volume 4000 and the cache volume 5000 are logical volumes having logical configurations by means of thin provisioning. The thin provisioning function is a function that provides the host computer 1000 with a virtual logical volume and dynamically allocates a storage area to the relevant logical volume when a request to write data to the virtual logical volume is issued from the host computer. When such a thin provisioning function is used, it is possible to provide the host computer with a virtual volume whose capacity is larger than a storage area which can be actually provided; and the thin provisioning function has an advantageous effect of the capability to reduce a physical storage capacity in the storage apparatus, which should be prepared in advance, and construct a computer system at low cost.

FIG. 4 illustrates a logical configuration of logical volumes (V-VOL), which constitute deduplicated volumes 4000 and the cache volume 5000 by means of thin provisioning. In response to access from the host computer 1000, a specified area 9002 is dynamically allocated to from a pool 9000 to the deduplicated volume 4000. On the other hand, an unused area 9001 of the pool 9000 which is not allocated to the deduplicated volumes 4000 is allocated to the cache volume 5000. The area 9001 which is allocated from the pool 9000 to the cache volume 5000 dynamically changes according to the allocation status of the pool 9000 to other logical volumes (V-VOL). The allocation status of each logical volume is managed by the volume management information 7001.

For example, the area 9001 to be allocated to the cache volume 5000 may be set in advance or be changed dynamically according to the allocation status of the deduplicated volumes 4000 and other logical volumes. In this way, it is possible to use the unused area effectively by flexibly changing the area to be allocated to the cache volume 5000 based on the data amount or the administrator' needs.

Moreover, the pool 9000 is configured as a set of management units called a plurality of pages and is composed of a plurality of pool volumes (which are indicated as Pool VOL in the drawing) 9003. One pool volume 9003 corresponds to a parity group 9004 of the RAID composed of a plurality of drives 3009.

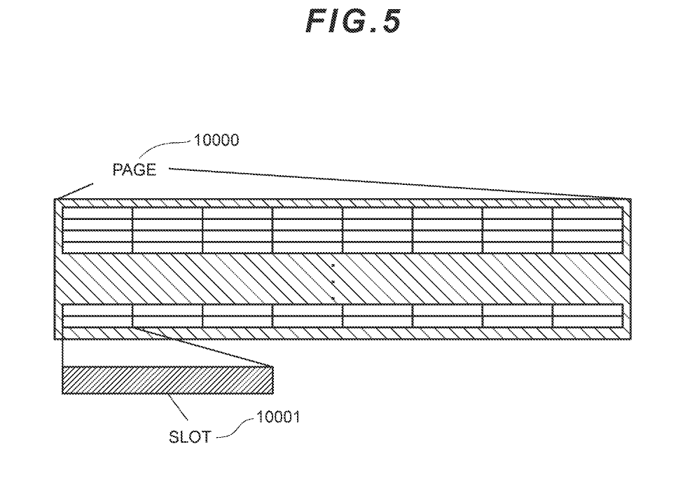

FIG. 5 illustrates a data management unit of the storage apparatus 3000 according to this embodiment. The data management unit is composed of a page 10000, which is a unit cut out from a logical volume pool, and a plurality of slots 10001 which constitute the page 10000. Data is removed on the slot 10001 basis from the cache memory 3005 as described above. Then, the deduplication processing is executed on the slot 10001 basis. The data unit may sometimes be hereinafter explained by using pages or slots.

Referring back to FIG. 3, according to this embodiment as described earlier, a data row to be stored in a deduplicated volume is divided by the deduplication processing into, and a distinction is made between, duplicate data chunks 4001 (S01, S02, S03 and so on), which duplicate another data row, and unique data chunks 4002 (C1, C2, C3 and so on) which do not include the duplicate data; and the duplicate part chunks 4002 which duplicate other data are gathered as 5001 (C1, C2, C3 and so on) and stored in consecutive areas in the cache volume 5000.

Then, when reading the data, the duplicate data 5001 recorded in the cache volume 5000 are collectively read and combined with the non-duplicate data stored in the deduplicated volumes 4000, and then staged to the cache memory as normally performed. As a result, it is possible to read the duplicate data from relatively consecutive addresses in the disks constituting the deduplicated volumes and increase the speed of sequential reading performance from the deduplicated volumes.

### (1-4) Various Tables

Next, the details of each table mentioned above will be explained.

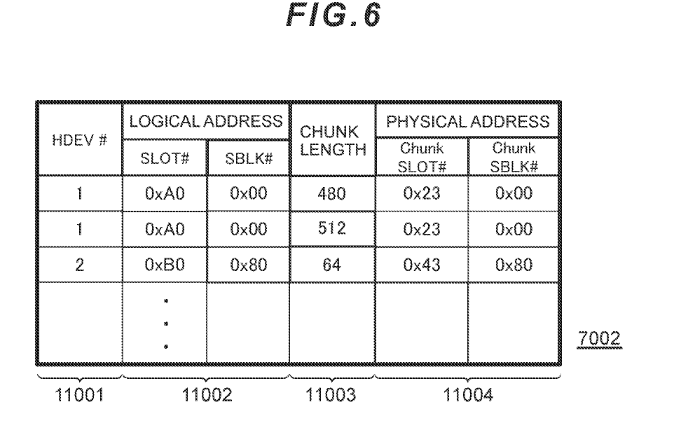

FIG. 6 is a chart showing an example of the deduplication address conversion table 7002. The deduplication address conversion table 7002 is a table for managing a correspondence relationship between logical addresses of deduplicated volumes and their physical addresses.

As illustrated in FIG. 6, the deduplication address conversion table 7002 is constituted from a volume identification number (which is indicated as HDEV (Host logical DEVice) in the drawing) column 11001, a logical address column 11002, a chunk length column 11003, and a physical address column 11004.

The volume identification number column 11001 stores the number for identifying the relevant logical volume. The logical address column 11002 stores a logical address indicated by a slot number (which is indicated as SLOT# in the drawing) and a subblock number (which is indicated as SBLK (Sub BLocK) # in the drawing) indicating, for example, a 512-byte or 520-byte unit which is a logical block size for standards such as IDE or SCSI, as a data management unit in the slot. The chunk length column 11003 stores a chunk length of a chunk corresponding to the logical address. The physical address column 11004 stores a physical address where the chunk corresponding to the logical address indicated by a chunk slot number (which is indicated as Chunk SLOT# in the drawing) and a chunk subblock number (which is indicated as Chunk SBLK# in the drawing) is stored.

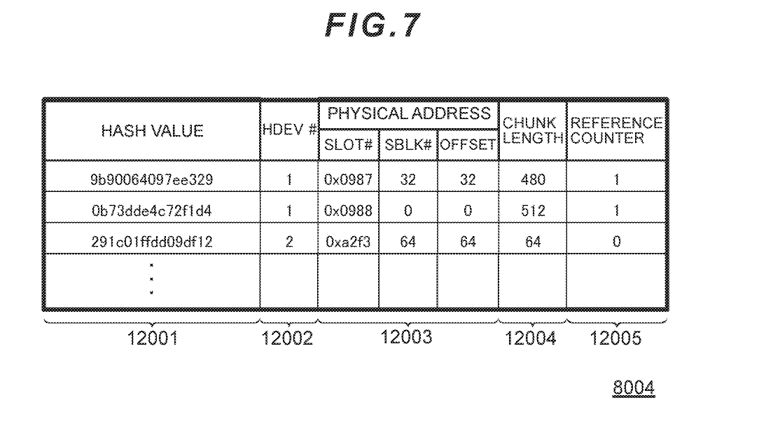

FIG. 7 is a chart showing an example of the chunk management table 8004. The chunk management table 8004 is a table for managing chunks stored in the deduplicated volumes 4000.

As illustrated in FIG. 7, the chunk management table 8004 is constituted from a hash value column 12001, a logical volume number column (which is indicated as HDEV# in the drawing) 12002, a physical address column 12003, a chunk length column 12004, and a reference counter column 12005.

The hash value column 12001 stores a hash value calculated from each chunk value in order to judge whether a chunk generated by the deduplication processing duplicates another data or not. The logical volume number column 12002 stores information for identifying the relevant logical volume. The physical address column 12003 stores a physical address where the relevant chunk indicated by the slot number (which is indicated as SLOT# in the drawing), the subblock number (which is indicated as SBLK# in the drawing), and offset is stored. The chunk length column 12004 stores a chunk length. The reference counter column 12005 stores a value indicating how many logical addresses refer to the relevant chunk.

For example, if the value of the reference counter column 12005 is 2 or more, it means that reference is made from two logical addresses to the relevant chunk. If the value of the reference counter column 12005 is 2 or more, it means that the relevant chunk is a duplicate chunk. Moreover, if the reference counter is 1, it means that reference is made from only one logical address to the relevant chunk and that the relevant chunk is a non-duplicate chunk. Furthermore, if the reference counter is 0, there is no logical address which refers to the relevant chunk and, therefore, the chunk can be recognized as an unused chunk and its data can be destroyed.

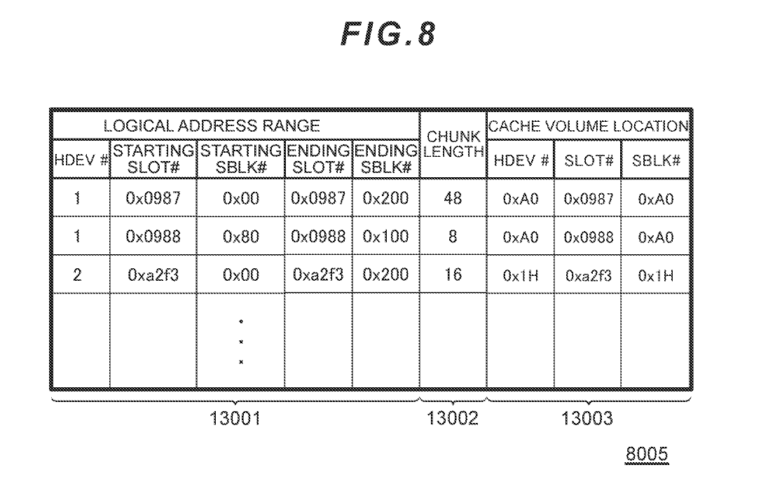

FIG. 8 is a chart showing an example of the cache volume management table 8005. The cache volume management table 8005 is a table for managing a cache area.

As illustrated in FIG. 8, the cache volume management table 8005 is constituted from a logical address range column 13001, a chunk length column 13002, and a cache volume location column 13003. The logical address range column 13001 stores a logical address range indicated by a logical volume number (HDEV#), a starting slot number (starting SLOT#), a starting subblock number (starting SBLK#), an ending slot number (ending SLOT#), and an ending subblock number (ending SBLK#). The chunk length column 13002 stores a chunk length of the relevant duplicate part chunk. The cache volume location column 13003 stores an address of a cache volume location indicated by the logical volume number (HDEV#), the slot number (SLOT#), and the subblock number (SBLK#).

For example, when a duplicate part chunk included in a certain logical address range in the deduplicated volume 4000 is cached to the cache volume 5000, the logical address range is stored in the logical address range column 13001 of the cache volume management table 8005 and the storage location of the duplicate part chunk included in the relevant logical address range is stored in the cache volume location column 13003.

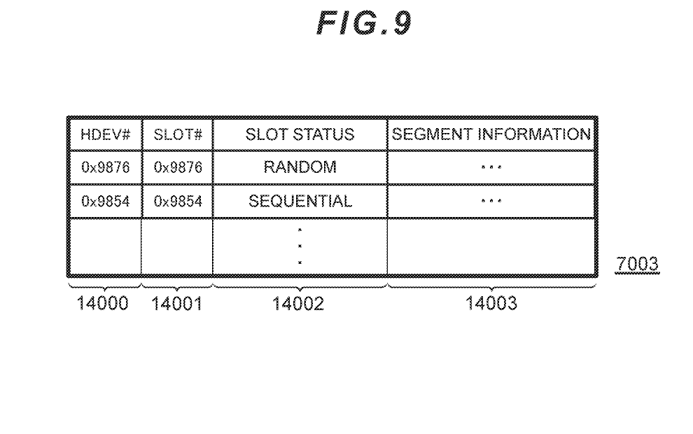

FIG. 9 is a chart showing an example of the cache memory management table 7003. The cache memory management table 7003 is a table for managing access patterns and segment information about data stored in the cache memory. Each row of the cache memory management table 7003 corresponds to one slot in the cache memory.

As illustrated in FIG. 9, the cache memory management table 7003 is constituted from a logical volume number (which is indicated as HDEV# in the drawing) column 14000, a slot number (SLOT#) column 14001, a slot status column 14002, and a segment information column 14003. The logical volume number column 14000 stores the number for identifying the relevant logical volume. The slot number column 14001 stores the number for identifying the relevant slot. The slot is uniquely identified by the logical volume number and the slot number. The slot status column 14002 stores information indicating the status of each slot and stores information about an access pattern, such as sequential access or random access, according to a data access pattern from the host computer 1000. The segment information column 14003 stores various information for managing segments which constitute each slot.

### (1-5) Deduplication Processing of Computer System

Next, the details of the deduplication processing will be explained. Firstly, the deduplication processing using the deduplicated volume 4000 and the cache volume 5000 will be explained.

### (1-5-1) Destaging Processing

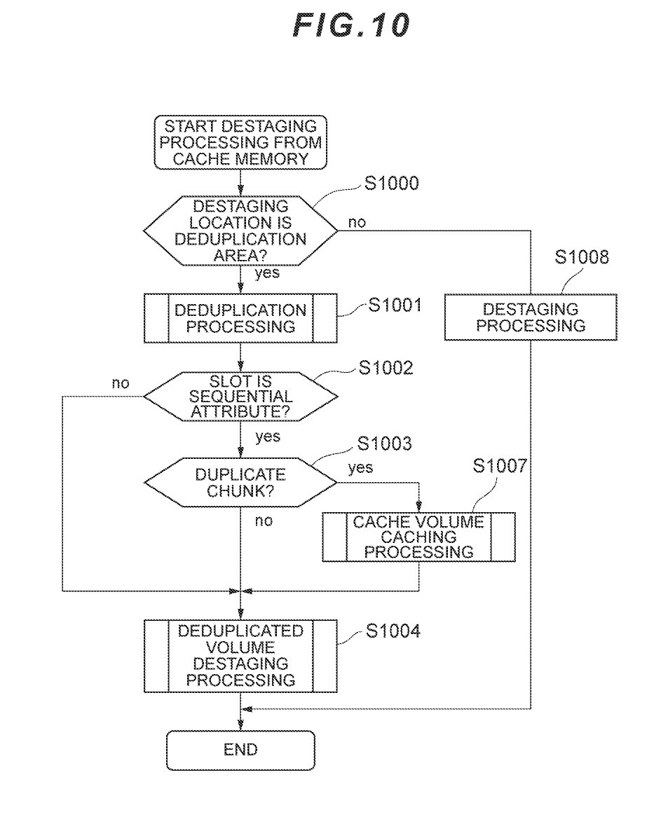

Processing for destaging a slot, which is stored in the cache memory 3005, to the deduplicated volume 4000 and processing for caching data to the cache volume 5000 will be explained with reference to FIG. 10.

Firstly, when destaging a slot 6001 from the data area 6000 of the cache memory 3005 in the storage apparatus 3000, the CPU 3003 for the storage apparatus 3000 judges whether a destaging location of the destaging target slot 6001 is a deduplication area or not (S1000). Specifically speaking, the CPU 3003 refers to the cache memory management information 7003 and the volume management information 7001 and judges whether the destaging location of the destaging target slot 6001 is a deduplicated volume 4000 or not.

If it is determined in step S1000 that the destaging location is the deduplicated volume 4000, the CPU 3003 issues a command to the deduplication engine 8000 to execute the deduplication processing (S1001). The deduplication processing in step S1001 will be explained later in detail.

On the other hand, if it is determined in step S1000 that the destaging location is not the deduplicated volume 4000, normal destaging processing is executed on a logical volume which is not the deduplicated volume 4000 (S1008).

Then, the CPU 3003 judges whether the destaging target slot 6001 has a sequential attribute or not (S1002). Specifically speaking, the CPU 3003 refers to the cache memory management information 7003 and judges whether the value of the slot status for an entry corresponding to the destaging target slot 6001 is sequential or random.

If it is determined in step S1002 that the slot 6001 has a random attribute, but not the sequential attribute, the CPU 3003 executes the destaging processing on the deduplicated volume (S1004). The destaging processing on the deduplicated volume step S1004 will be explained later in detail.

On the other hand, if it is determined in step S1002 that the slot 6001 has the sequential attribute, the CPU 3003 judges whether a chunk in the relevant slot 6001 is a duplicate chunk or not (S1003).

If it is determined in step S1003 that the chunk included in the slot 6001 is a duplicate chunk, the CPU 3003 executes cache processing for storing that chunk in the cache volume 5000 (S1007). On the other hand, if it is determined in step S1003 that the chunk included in the slot 6001 is not a duplicate chunk, the CPU 3003 executes destaging processing for storing the relevant chunk in the deduplicated volume 4000 (S1004).

### (1-5-2) Deduplication Processing

Next, the details of the above-mentioned deduplication processing by the deduplication engine 8000 in step 1001 will be explained.

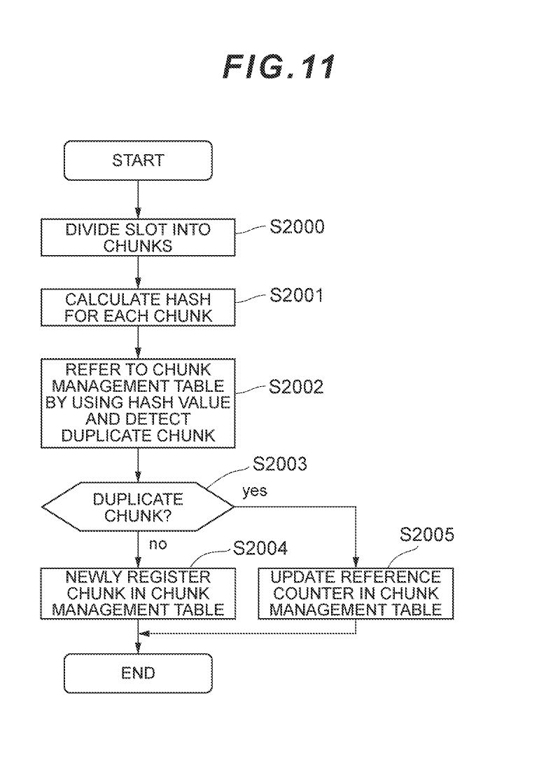

The deduplication engine 8000 firstly divides the slot 6001 which is a target of the deduplication processing into chunks (S2000) as illustrated in FIG. 11. Regarding the division into chunks in step S2000, the slot 6001 may be divided into chunks of a fixed length or chunks of variable lengths.

Then, the deduplication engine 8000 calculates a hash value of each chunk divided in step S2000 (S2001). Specifically speaking, the deduplication engine 8000 calculates the hash value of the chunks by using SHA (Secure Hash Algorithm)-1 or SHA-256.

Then, the deduplication engine 8000 refers to the chunk management table 8004 and detects a duplicate chunk for each chunk (S2002). Specifically speaking, the deduplication engine 8000 compares the hash value of each chunk calculated in step S2002 with the value of the hash value column 12001 in the chunk management table 8004 to check whether there is any matching hash value or not. If there is a matching hash value in the chunk management table 8004, this means that the relevant chunk is a duplicate chunk; and if there is no matching hash value, this means that the relevant chunk is a non-duplicate chunk.

Then, if it is determined as a result of the detection in step S2002 that the chunk is a duplicate chunk, the deduplication engine 8000 updates the reference counter in the chunk management table 8004 (S2005). Specifically speaking, the deduplication engine 8000 increments the value of the reference counter column 12005 in the chunk management table 8004 by one.

On the other hand, if it is determined as a result of the detection in step S2002 that the chunk is not a duplicate chunk, the deduplication engine 8000 newly registers that chunk in the chunk management table 8004. Specifically speaking, the deduplication engine 8000 adds an entry including information about the hash value of the relevant chunk, the logical volume and the physical address where the relevant chunk is stored, and the chunk length to the chunk management table 8004.

### (1-5-3) Destaging Processing on Deduplicated Volume

Next, the above-mentioned destaging processing on the deduplicated volume in step S1004 will be explained.

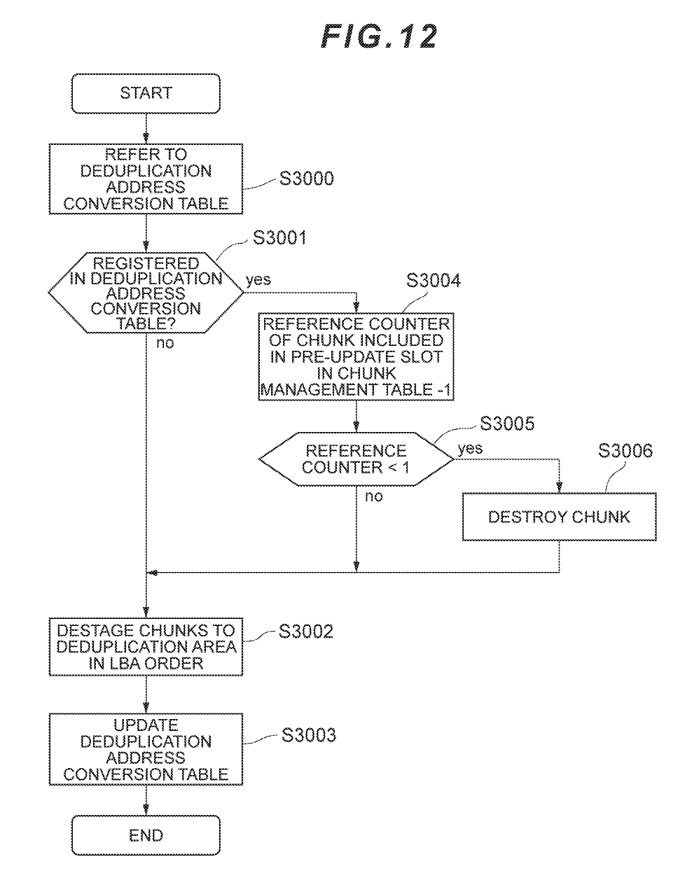

As illustrated in FIG. 12, the CPU 3003 refers to the deduplication address conversion table 7002 (S3000) and judges whether the destaging target slot 6001 is registered in the deduplication address conversion table 7002 or not (S3001). Specifically speaking, the CPU 3003 checks if the logical address of the destaging target slot 6001 is registered in the deduplication address conversion table 7002.

If it is determined in step S3001 that the destaging target slot 6001 is registered in the deduplication address conversion table 7002, the CPU 3003 decrements the value of the reference counter column 12005 in the chunk management table 8004 by one (S3004). When the destaging target slot 6001 is registered in the deduplication address conversion table 7002 in step S3001, this means that information about the relevant slot 6001 has already been registered in the chunk management table 8004. Therefore, regarding the entry whose reference relationship was updated by incrementing the reference counter in step S3004, it is necessary to decrement the value of the reference counter column 12005 in step S3004 in order to dissolve the above reference relationship once.

Then, the CPU 3003 judges whether the value of the reference counter has become less than 1 as a result of decrementing the value of the reference counter column 12005 in the chunk management table 8004 by one in step S3004 (S3005).

If it is determined in step S3005 that the value of the reference counter column 12005 in the chunk management table 8004 has become less than 1, the CPU 3003 destroys the chunk (S3006) and executes processing in step S3002 and subsequent steps. On the other hand, if it is determined in step S3005 that the value of the reference counter column 12005 in the chunk management table 8004 is equal to or more than 1, the CPU 3003 executes the processing in step S3002 and subsequent steps.

The CPU 3003 destages target chunks in an LBA order to the deduplicated volume 4000 (S3002). Then, the CPU 3003 updates the deduplication address conversion table 7002 (S3003). Specifically speaking, the CPU 3003 stores the logical address of the deduplicated volume for the target chunks and the physical address corresponding to the logical address to the deduplication address conversion table 7002.

### (1-5-4) Cache Processing on Cache Volume

Next, the aforementioned cache processing on the cache volume in step S1007 will be explained. The processing for caching data to the cache volume 5000 is executed by the deduplication engine 8000.

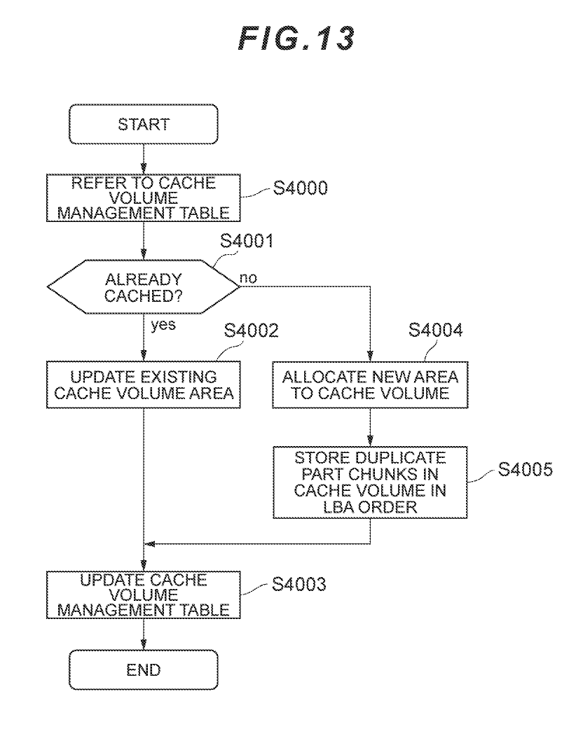

As illustrated in FIG. 13, the deduplication engine 8000 refers to the cache volume management table 8005 (S4000) and judges whether or not a cache target slot 6001 has already been cached to the cache volume 5000 (S4001). Specifically speaking, the deduplication engine 8000 judges whether or not the logical address range of the cache target slot 6001 is included in the logical address range column 13001 of the cache volume management table 8005.

If it is determined in step S4001 that the cache target slot 6001 has already been cached, the deduplication engine 8000 updates the relevant area of the existing cache volume 5000 (S4002). On the other hand, if it is determined in step S4001 that the cache target slot 6001 has not been cached yet, the deduplication engine 8000 executes processing in step S4004 and subsequent steps.

The deduplication engine 8000 secures an area in the cache volume 5000 to cache chunks in step S4004 (S4004). Specifically speaking, the deduplication engine 8000 allocates a new physical area in a specified area of the cache volume 5000. Then, the deduplication engine 8000 stores duplicate chunks in specified consecutive physical areas (physical areas composed of consecutive physical addresses (PBA)) of the cache volume 5000, to which the area has been newly added, in the order of logical addresses (LBA order).

Then, the deduplication engine 8000 updates the cache volume management table 8005 (S4003). Specifically speaking, the deduplication engine 8000 reflects the update content of the cache volume 5000 in step S4002 and the update content of the cache volume 5000, to which the area was newly allocated in steps S4004 and 4005, in the cache volume management table 8005.

### (1-5-5) Read Processing

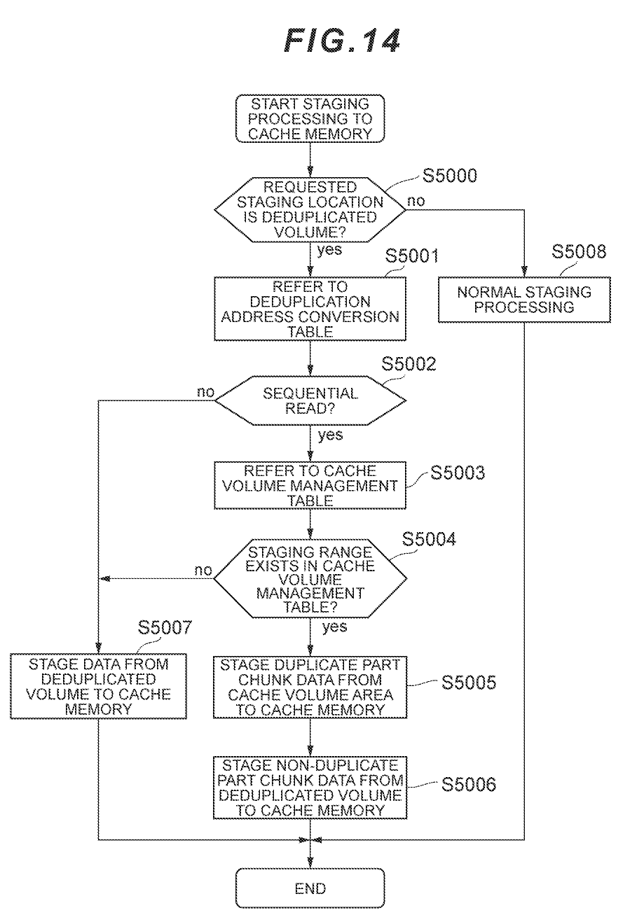

Next, data read processing will be explained with reference to FIG. 14. Processing for reading data from the deduplicated volume 4000 and staging the data to the data area 6000 of the cache memory 3005 will be explained below.

Firstly, the CPU 3003 for the storage apparatus 3000 receives a read command from the host computer 1000 and starts processing for staging data to the cache memory 3005. Specifically speaking, the CPU 3003 receives the read command from the host computer 1000 and stages data, which is requested from a logical volume, to the data area 6000 of the cache memory 3005.

As triggered by a data staging request, the CPU 3003 judges whether a volume to be staged to the cache memory 3005 is a deduplicated volume or not (S5000).

If it is determined in step S5000 that the volume to be staged to the cache memory 3005 is not a deduplicated volume, the CPU 3003 executes normal staging processing (S5008).

On the other hand, if it is determined in step S5000 that the volume to be staged to the cache memory 3005 is the deduplicated volume 4000, the CPU 3003 refers to the deduplication address conversion table 7002 and acquires information about chunks included in the relevant logical address range from the logical address of the read request chunk (S5001).

Then, the CPU 3003 judges whether a read access pattern of the host computer 1000 is sequential read or not (S5002).

If it is determined in step S5002 that it is not sequential reading, the CPU 3003 executes processing in step S5007 and subsequent steps. On the other hand, if it is determined in step S5002 that it is sequential reading, the CPU 3003 executes processing in step S5003 and subsequent steps.

The CPU 3003 refers to the cache volume management table 8005 in step S5003 and judges whether the staging request range is included in the logical address range of the cache volume management table 8005 (S5004).

If it is determined in step S5004 that the staging request range is included in the logical address range of the cache volume management table 8005, the CPU 3003 stages data of the duplicate part chunks 5001 in the staging target logical address range from the cache volume 5000 to the cache memory 3005 (S5005). Furthermore, the CPU 3003 stages data of non-duplicate chunks of the deduplicated volume 4000 to the cache memory 3005 (S5006).

On the other hand, if it is determined in step S5004 that the staging request range is not included in the logical address range of the cache volume management table 8005, the CPU 3003 executes processing in step S5007 and subsequent steps.

In step S5007, the CPU 3003 stages data of the staging request range from the deduplicated volume 4000 to the cache memory 3005 (S5007).

If duplicate part chunks in a logical address range preceding the logical address range requested to the storage apparatus 3000 by the host computer 1000 exist in the cache volume 5000, the relevant chunks may be staged by reading them ahead. In this way, sequential reading of data from the host computer 1000 can be streamlined by reading the duplicate part chunks 4000 ahead and staging them.

### (1-6) Advantageous Effects of This Embodiment

According to this embodiment, a data row to be stored in a deduplicated volume is divided by the deduplication processing into data which duplicates another data row (duplicate part data), and data which does not include the duplicate data (non-duplicate part data); and the duplicate part data are recorded in consecutive unused areas in the disks and the non-duplicate part data are stored in the deduplicated volume. Then, when reading data, the duplicate part data recorded in the unused area are collectively read and staged normally to the cache memory. As a result, the data can be read from relatively consecutive physical addresses in the disks constituting the deduplicated volume, so that the speed of the sequential read performance from the deduplicated volume is increased.

### (2) Second Embodiment

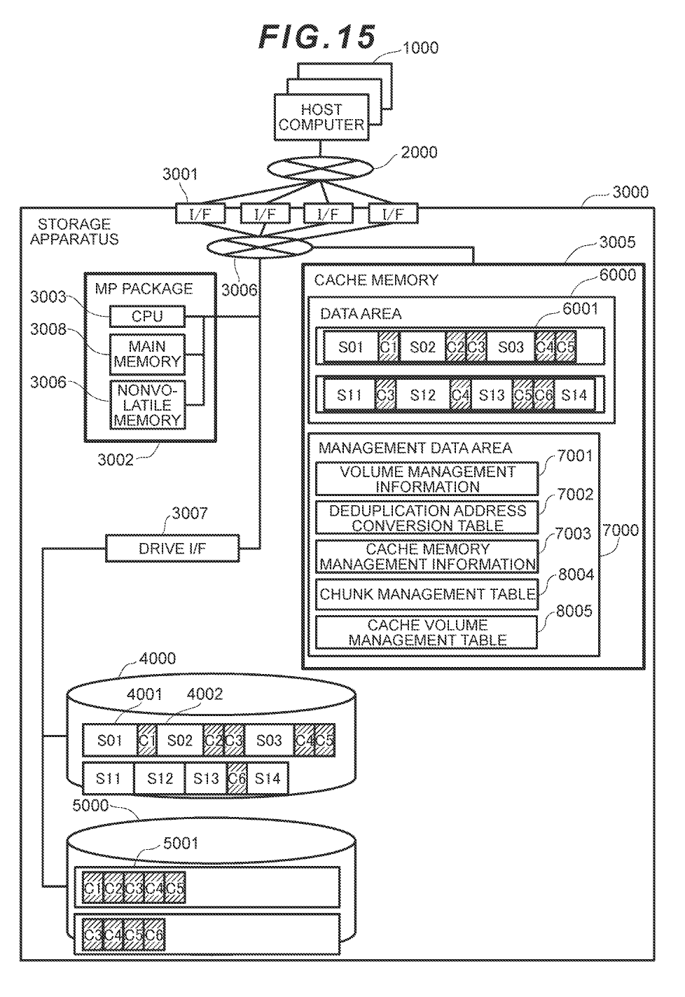

Next, a second embodiment will be explained. Elements which are different from those of the first embodiment will be explained below in detail, while any detailed explanation about the same elements as those of the first embodiment has been omitted. In the first embodiment, the deduplication engine 8000 which executes only the deduplication processing is mounted in the storage apparatus 3000. However, the configuration of this embodiment is different from that of the first embodiment because it is not equipped with the deduplication engine 8000 as shown in FIG. 15 and the CPU 3003 executes the deduplication processing. Specifically speaking, the CPU 3003 activates a duplication program stored in the nonvolatile memory 3006 and executes the deduplication processing.

Moreover, the chunk management table 8004 and the cache volume management table 8005 which are stored in the memory 8002 for the deduplication engine 8000 are stored in a management data area 7000 of the cache memory 3005. Accordingly, the CPU 3003 can execute the destaging processing, the deduplication processing , the destaging processing for destaging data to the deduplicated volume, the cache processing for caching data to the cache volume, and the read processing in the same manner as in the first embodiment by activating the deduplication program in the nonvolatile memory 3006 and referring to each table in the cache memory 3005.

According to this embodiment, even if the storage apparatus 3000 is not equipped with the deduplication engine 8000, a data row which should be stored in the deduplicated volume is divided the deduplication processing into data which duplicates another data row (duplicate part data), and data which does not include the duplicate data (non-duplicate part data), and the duplicate part data are recorded in consecutive unused areas in the disks and the non-duplicate part data are stored in the deduplicated volume. Then, when reading data, the duplicate part data recorded in the unused areas are collectively read and staged to the cache memory. As a result, the data can be read from relatively consecutive addresses in the disk constituting the deduplicated volume, so that the speed of the sequential read performance from the deduplicated volume can be increased.

### (3) Third Embodiment

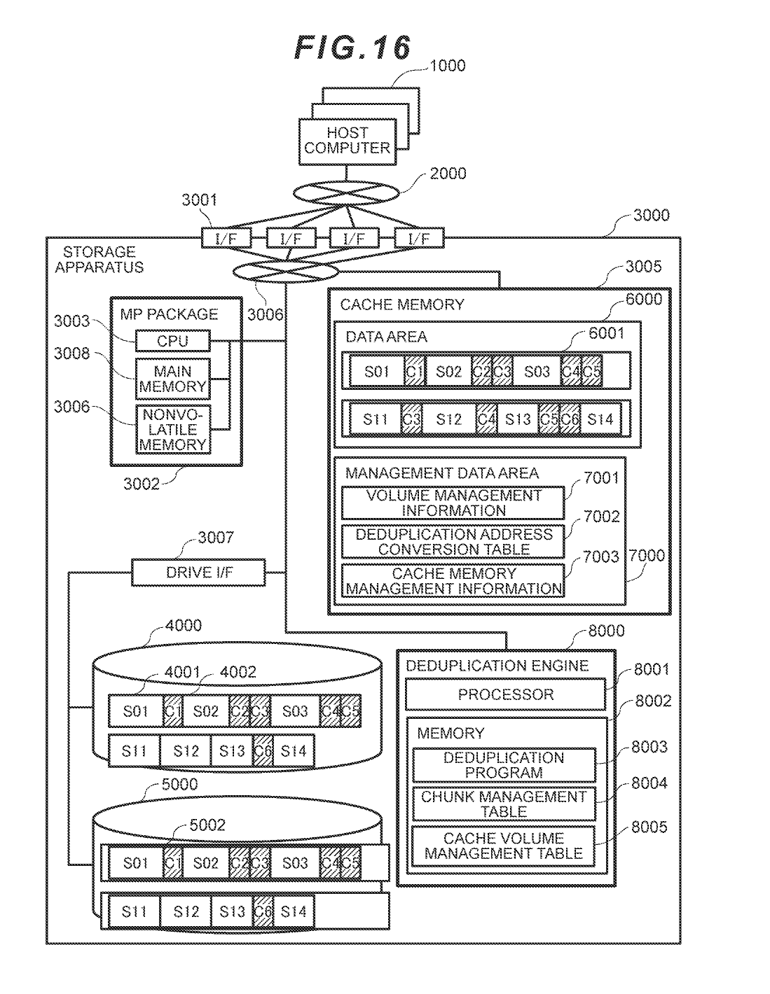

Next, a third embodiment will be explained with reference to FIG. 16. Elements which are different from those of the first embodiment will be explained below in detail, while any detailed explanation about the same elements as those of the first embodiment has been omitted. In the first embodiment, only the duplicate part chunks 5001 which are obtained by dividing data by the deduplication processing is cached to the cache volume 5000; however, the invention is not limited to this example. The configuration of this embodiment is different from that of the first embodiment because data which are staged to the cache memory 6000 are cached to the cache volume 5000 as it is.

According this embodiment, not only the data of the duplicate part chunks, but also the data 5002 themselves which are staged to the cache memory 6000 by the staging processing are stored in the cache volume 5000 during the destaging processing (the cache processing for caching data to the cache volume). As a result, when staging the deduplicated data, it is no longer necessary to refer to the chunk management table 8004 and the cache volume management table 8005 and execute processing for converting the non-duplicate chunk data and the duplicate chunk data into read target data. Therefore, the processing is simplified, so that the speed of the sequential read processing can be increased.

### (4) Fourth Embodiment

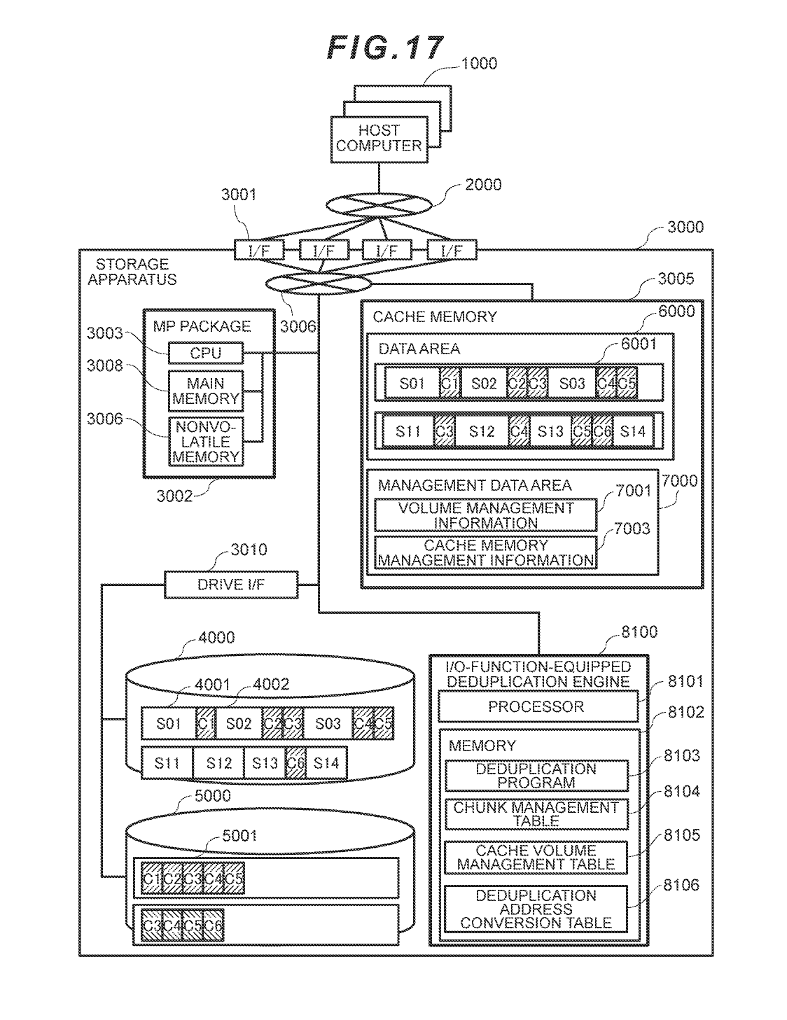

Next, a fourth embodiment will be explained with reference to FIG. 17. Elements which are different from those of the first embodiment will be explained below in detail, while any detailed explanation about the same elements as those of the first embodiment has been omitted. In this embodiment, the storage apparatus 3000 is equipped with the deduplication engine in the same manner as in the first embodiment. However, this embodiment is different from the first embodiment because a deduplication engine 8100 according to this embodiment executes I/O processing on the deduplicated volume. The I/O processing on the deduplicated volume is, for example, not only the deduplication processing, but also processing necessary for the processing for reading and writing the data of the deduplicated volume such as address conversion of the deduplicated volume. As the processor 8101 for the deduplication engine 8100 executes such deduplication processing, the CPU 3003 for the storage apparatus 3000 can treat the deduplicated volume 4000 the same as a normal volume which is not deduplicated.

Since the deduplication engine 8100 equipped with the I/O function is mounted in this way, the deduplicated volume 4000 is virtualized. Therefore, the CPU 3003 for the storage apparatus 3000 can treat the deduplicated volume without being conscious of deduplication of the data and in the same manner as in a case where the volume is not deduplicated. So, even if both a deduplicated volume and a normal volume exist in one storage apparatus 3000, the I/O processing can be simplified.

As one of the characteristics of the aforementioned first to fourth embodiments, the invention can be configured so that a first storage area (a deduplicated volume) and a second storage area (a cache volume) are provided to a host system, a first data row which is deduplicated is stored in the first storage area, and a second data row generated based on a data row that is the first data row before being deduplicated is stored in consecutive areas of physical areas constituting the second storage area.

Because of this configuration, data which are stored in the consecutive areas, but not data which are deduplicated and fragmented, can be staged, so that it is possible to enhance the access performance.

As another characteristic, the invention can be configured so that a plurality of storage media and a cache memory are provided; the plurality of storage media provide the host system with the first storage area (the deduplicated volume) and the second storage area (the cache volume); the first storage area retains the first data row which is deduplicated and the second data row which is generated based on the data row that is the first data row before being deduplicated is retained in the consecutive areas of the physical areas constituting the second storage area; and when access received by the storage apparatus during the processing for staging data from the first or second storage area to the cache memory is sequential access, the data is staged from the second storage area.

Because of this configuration, data which are stored in the consecutive areas, but not data which are deduplicated and fragmented, can be staged, so that it is possible to enhance the access performance.

As a further characteristic, a plurality of storage media and a cache memory are provided; the plurality of storage media provides the host system with the first storage area (the deduplicated volume) and the second storage area (the cache volume); and when destaging a data row in the cache memory (also referred to as caching with respect to the second storage area), the first data row obtained by executing the processing for deduplicating the data row in the cache memory is stored in the first storage area, and the second data row generated based on data included in the data row in the cache memory is stored in the consecutive areas of physical areas constituting the second storage area. Because of this configuration, it is possible to enhance the access performance when reading data.

Regarding the plurality of above-described characteristics, examples of the second data row can be a data row composed of the duplicate data and a data row to be staged to the cache memory (data row before being deduplicated). The second storage area can be used efficiently by storing the data row composed of the duplicate data as the second data row. Moreover, when the data row itself, which is to be staged to the cache memory, is used as the second data row, it is no longer necessary to restore the read target data and it is possible to enhance the access performance. Furthermore, if the second storage area is composed of HDDs, it is possible to enhance the sequential access performance.

### REFERENCE SIGNS LIST

1000 host computer
2000 network
3000 storage apparatus
3002 microprocessor package
3005 cache memory
3009 drive
4000 deduplicated volume
5000 cache volume

1. A storage system comprising:
a plurality of storage media;
a cache memory;
a control unit for controlling inputting of data to, and outputting of data from, the storage media,
wherein the control unit:
provides a host system with a first storage area composed of storage areas of the plurality of storage media and a second storage area having the same performance characteristic as that of the storage media which provide the first storage area; and
stores a first data row, which is deduplicated, in the first storage area and a second data row, which is created based on a data row that is the first data row before being deduplicated, in consecutive areas of physical areas constituting the second storage area.

2. The storage apparatus according to claim 1, wherein when access received from the host system during processing for staging data from the first storage area or the second storage area to the cache memory is sequential access, the control unit stages data from the second storage area.

3. The storage apparatus according to claim 1, wherein when destaging a data row in the cache memory, the control unit stores the first data row, which is obtained by executing processing for deduplicating the data row in the cache memory, in the first storage area and stores the second data row, which is created based on the data row in the cache memory, in the consecutive areas of the physical areas constituting the second storage area.

4. The storage apparatus according to claim 1,
wherein the second data row includes a data row composed of duplicate data; and
wherein the control unit stores the data row composed of the duplicate data in the second storage area.

5. The storage apparatus according to claim 1,
wherein the second data row includes a data row to be staged to the cache memory; and
wherein the control unit stores the data row to be staged to the cache memory in the second storage area.

6. The storage apparatus according to claim 1, wherein in response to a data write request from the host system, the control unit allocates an unallocated area of the storage media to the first storage area and an area, which has not been allocated to the first storage area, of a storage area of the storage media having the same performance characteristic as that of the above storage media, to the second storage area.

7. A data management method for a storage system including:
a plurality of storage media;
a cache memory;
a control unit for controlling inputting of data to, and outputting of data from, the storage media,
the data management method comprising:
a first step executed by the control unit providing a host system with a first storage area composed of storage areas of the plurality of storage media and a second storage area having the same performance characteristic as that of the storage media which provide the first storage area; and
a second step executed by the control unit storing a first data row, which is deduplicated, in the first storage area and a second data row, which is created based on a data row that is the first data row before being deduplicated, in consecutive areas of physical areas constituting the second storage area.

8. The data management method according to claim 7, further comprising a third step executed, when access received from the host system during processing for staging data from the first storage area or the second storage area to the cache memory is sequential access, by the control unit staging data from the second storage area.

9. The data management method according to claim 7, further comprising a fourth step executed when destaging a data row in the cache memory, by the control unit storing the first data row, which is obtained by executing processing for deduplicating the data row in the cache memory, in the first storage area and storing the second data row, which is created based on the data row in the cache memory, in the consecutive areas of the physical areas constituting the second storage area.

10. The data management method according to claim 7,
wherein the second data row includes a data row composed of duplicate data and a data row to be staged to the cache memory; and
wherein the data management method further comprises a fifth step executed by the control unit storing the data row composed of the duplicate data as the second data row in the second storage area in the second step.

11. The data management method according to claim 7,
wherein the second data row includes a data row composed of duplicate data and a data row to be staged to the cache memory; and
wherein the data management method further comprises a sixth step executed by the control unit storing the data row to be staged to the cache memory as the second data row in the second storage area in the second step.

12. The data management method according to claim 7, further comprising a seventh step executed, in response to a data write request from the host system, by the control unit allocating an unallocated area of the storage media to the first storage area and an area, which has not been allocated to the first storage area, of a storage area of the storage media having the same performance characteristic as that of the above storage media, to the second storage area.
